(19) United States
(12) Patent Application Publication
(10) Pub. No.: US 2012/0106399 A1
(43) Pub. Date: May 3, 2012

(54) IDENTITY MANAGEMENT SYSTEM

(75) Inventors: Joerg Abendroth, Munchen (DE); Markus Bauer-Hermann, Aicha vorm Wald (DE); Gerald Meyer, Puchheim-Bhf (DE); Robert Seidl, Konigsdorf (DE)

(73) Assignee: NOKIA SIEMENS NETWORKS OY, Espoo (FI)

(21) Appl. No.: 13/381,690

(22) PCT Filed: Aug. 27, 2009
(86) PCT No.: PCT/EP2009/061047

§ 371 Date: Dec. 30, 2011

(51) Int. Cl. H04L 12/28

(52) U.S. Cl. 370/255

(57) ABSTRACT

A local identity management module is described that is able to identify each of a plurality of user devices. The user devices communicate with the outside world via a network address translation device that converts an internal address of the user devices to a single internet protocol address, typically the internet protocol address of the network address translation device. An external identity management system can communicate with the local identity management module in order to identify which of said plurality of user devices made a particular request and, in some embodiments, to identify a user of said user device.

The present invention is directed to identity management. In particular, the invention is directed to identity management in situations where a number of devices with separate identities are associated with a network address translation device.

Network address translation (NAT) devices translate network address information while data is moving through the NAT device. This is used, for example, to allow a number of different devices to effectively share the same network address. NAT devices are often used in residential environments to connect a number of devices to the Internet using a single Internet Protocol (IP) address.

Each customer of an Internet Service Provider (ISP) is typically allocated a very limited number of IP addresses. NAT devices enable the same IP address to be effectively allocated to more than one device, thereby enabling more devices to be connected to the Internet than that customer has IP addresses.

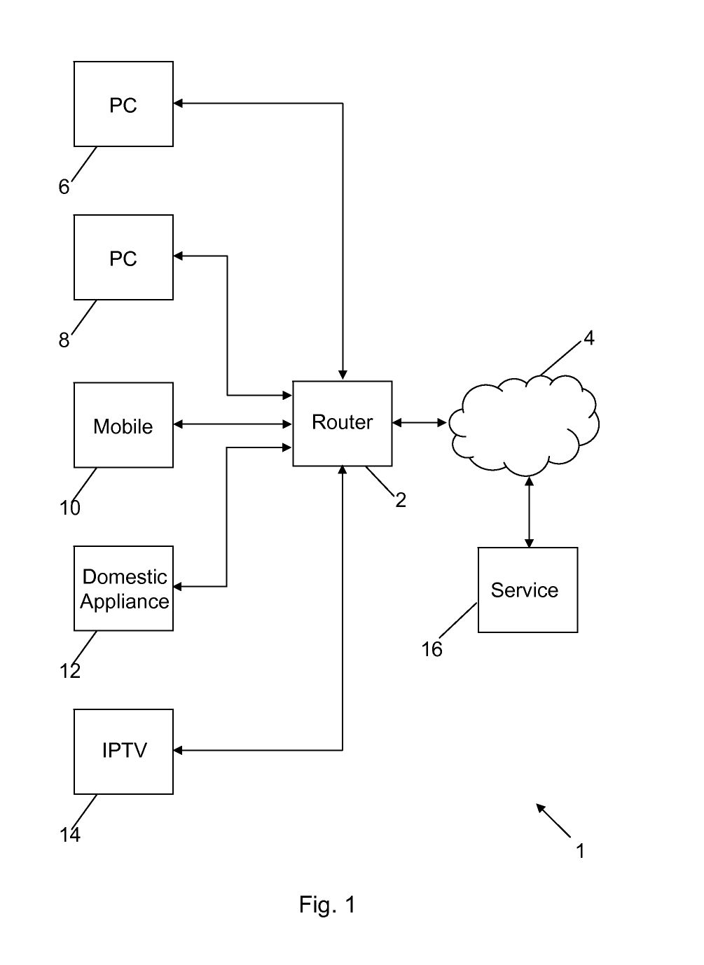

FIG. 1 is a block diagram of a system, indicated generally by the reference numeral 1, showing an exemplary use of a NAT device.

The system 1 comprises a router 2, which router is a NAT device. The router 2 is in two-way communication with a network 4, such as the Internet. The router 2 is also in two-way communication with a first laptop 6, a second laptop 8, a mobile communication device with internet access 10, a smart domestic appliance (such as a refrigerator) 12 and an Internet Protocol television (IPTV) 14. The system 1 shows a service 16 coupled to the network 4. The service 16 may be accessed by one or more of the laptops 6 and 8, mobile communication device 10, appliance 12 or IPTV 14 via the NAT 2 and the network 4. Although only a single service is shown in the arrangement of FIG. 1, the system 1 can be used to provide the user devices 6, 8, 10, 12 and 14 with access to a plurality of services and service providers.

As noted above, the router 2 is an NAT device. In one implementation of the system 1, each of the devices 6, 8, 10, 12 and 14 appear to devices outside the local network (such as the service 16) to share a single IP address, typically the IP address of the router.

NAT devices, such as the router 2, are well known in the art. By way of example, each of the devices 6, 8, 10, 12 and 14 may be allocated a unique IP address within the system 1. The router 2 then rewrites IP packets as those packets exit the router 2 so that the packets appear to originate from the router, and not from the particular device concerned.

Incoming IP packets are mapped back to the originating device using rules stored in a translation table maintained by the router 2.

Single-sign-on is an established mechanism for enabling a user to access a service that requires user credentials, without requiring the user to manually provide such credentials each time the service is accessed. In Internet Protocol (IP) networks, an IP address can be used to identify a device and can be used to provide access to a service, such as the service 16 described above. However, for the reasons discussed above, the use of the router 2 as an NAT device hides the IP address of the device accessing the service.

Accordingly, in the system 1, the service 16 cannot uniquely identify the requesting party and so single-sign-on based methods using an IP-address to identify individual users are generally incompatible with the use of NAT devices.

One known mechanism for addressing the problem of authenticating a user in such a situation is to prompt the user to enter a username and/or a password. Thus, single-sign-on is not provided. However, even this partial solution to the problem is not possible if the user is not able to enter a username or a password. For example, if the user device is the IPTV 14, the user may not have an adequate user interface with which to provide the required user credentials. Moreover, if the user device is the smart domestic appliance 12 described above, there may not even be a human user involved who could provide the required user credentials.

An alternative mechanism for addressing the problem in the prior art is to rely on end devices sharing a secret with the service 16. In the case of a home network, this requires the user to store his authentication credentials potentially on several devices, each of which need to be secured against attacks. Although such a method can be used to provide single-sign-on (SSO) functionality, the additional administrative overhead for users can often be greater than the added convenience of SSO.

The present invention seeks to address at least some of the problems outlined above.

According to an aspect of the invention, there is provided an apparatus comprising: a first input for receiving a request from an identity management system (possibly redirected via the first user device) to identify a first user device requesting access to a service, wherein the first user device is one of a plurality of user devices that communicate with one or more services via a network address translation device that converts an identifier (typically an address and often a unique address for each of the user devices) for each of the user devices into a common identifier (typically an address) shared by the user devices; processing means for identifying said first user device; and a first output for providing data (often the said identifier for the user device concerned) to said identity management (IDM) system (possibly sent via the first user device using redirection) identifying said first user device.

The apparatus of the invention may be at the same site as the first user device. The apparatus of the invention may be at the same site as the network address translation device and may, indeed, form a part of the network address translation device.

Typically, the apparatus forms part of a local network, together with the first user device (and possibly many user devices). The service provider and/or the IDM may be provided remotely and may, for example, be connected to the apparatus via a network, such as the Internet.

The apparatus may further comprise a second input (which may be the same physical input as the first input) for receiving a request from the identity management system to indicate whether or not the apparatus is able to provide the said data identifying the first user device. (This is typically carried out prior to carry out the steps described above.) Thus, the IDM may first ascertain whether the apparatus is able to identify a particular user and, if so, the IDM may then ask the apparatus to provide identification information for that user.

In many forms of the invention, the network address translation device is a router.

The common identifier (which may be an IP address) is typically the address of the network translation device.

The apparatus of the invention may form part of the said network address translation device (either as a single apparatus, or as a distributed apparatus). Furthermore, the network address translation device may further comprise a third input and a second output, wherein: the third input is adapted to receive a service access request from one of the plurality of user devices; each of said user devices has an individual identifier (such as a unique address); the second output is adapted to send an access request to the requested service; and the access request identifies the requesting user device using said common identifier (typically an address, such as an internet protocol address), regardless of the identity of the requesting user. The third input and/or the second output may be provided as part of the same physical resources as one or more of the other inputs and outputs.

In accordance with a further aspect of the invention, there may be provided a system comprising an apparatus as set out above and further comprising the said identity management system.

In accordance with a further aspect of the invention, there is provided an apparatus (such as an IDM) comprising: a first input for receiving an assertion request (that might originate at a service provider), typically from a network address translation device (such as a router), wherein the assertion request relates to one of a number of users or user devices sharing a common identifier (typically an address); a first output for sending a query to the network address translation device requesting information regarding whether or not the network address translation device can provide a unique identifier for said user device; and a second input for receiving an indication from the network address translation device regarding whether or not the network address translation device can provide said unique address. The apparatus may further comprise a second output for sending a query to a local identity management module requesting identification information for the user device; a third input for receiving identification information for the user device from the local identity management module; and a third output for providing an assertion response in response to the assertion request, wherein the assertion response. At least some of the inputs and outputs may be provided on shared inputs and/or outputs.

In accordance with a further aspect of the invention, there is provided an apparatus comprising: a first input for receiving an assertion request (typically from a network address translation device, but often originating at a service provider), wherein the assertion request relates to one of a number of users sharing a common identifier; a first output for sending a query to a local identity management module requesting identification information for the user device; a second input for receiving identification information for the user device from the local identity management module; and a second output for providing an assertion response in response to the assertion request.

In accordance with another aspect of the invention, there is provided a method comprising: receiving (typically at an IDM) an assertion request, typically from a network address translation device (such as a router), wherein the assertion request relates to one of a plurality of users or user devices sharing a common identifier (such as a common IP address, typically the IP address of a router used by the plurality of users); sending a query to the network address translation device requesting information regarding whether or not the network address translation device can provide a unique address for said user device; and receiving an indication from the network address translation device regarding whether or not the network address translation device can provide said unique address.

In accordance with a further aspect of the invention, there is provided a method comprising: receiving (for example at a network address translation device, such as a router) a request from an identity management system to identify a first user device requesting access to a service, wherein the first user device is one of a plurality of user devices communicating with one or more services via a network address translation device that converts an identifier for each user device (known to the apparatus) into a common identifier (typically an address) shared by the user devices; identifying said first user device; and providing data to said identity management system identifying said first user device.

The method may further comprising receiving a request from the identity management system to indicate whether or not the apparatus is able to provide the data identifying the first user device.

The common identifier (which may be an IP address) may be the identifier or address of the network translation device.

The method may further comprise: receiving a service access request from one of the plurality of user devices; and sending an access request to the requested service, wherein the access request identifies the requesting user using the common identifier (typically an internet protocol address), regardless of the identity of the requesting user. The access request may be sent to the requested service via an Internet Protocol network (such as the Internet).

In accordance with a further aspect of the invention, there is provided a method comprising: sending a service access request from one of a plurality of user devices to a first service via a network address translation device, wherein the network address translation device provides the request in a format that includes a common address (such as a single internet protocol address), regardless of the internal address of said one of the plurality of user devices; the first service requesting an identification assertion for the user device from an identity management system; the identity management system requesting identification information for the user device from a local identity management module; the local identity management module providing identification information for said one of said plurality of user devices to the identity management system; the identity management system providing an identity assertion to the service on the basis of identification information received from the local identity management system; and the first service granting the user device access to the service.

The method may further include checking that the local IDM system is able to identify the requesting user device.

In accordance with a further aspect of the invention, there is provided a system comprising a network address translation module and a local identity management module, wherein: the network address translation module comprises: a first input adapted to receive a service access request from one of a plurality of user devices, wherein each of said user devices has an individual identifier; a first output for sending an access request to the requested service, wherein the access request identifies the requesting user using a common address (such as the same internet protocol address), regardless of the identity of the requesting user; the local identity management module comprises: a first input for receiving a request from an identity management system to identify said one of said plurality of user devices; processing means for identifying said one of said plurality of user devices; a second output for providing data to said identity management system identifying said one of said plurality of user devices.

The apparatus and said plurality of user device may comprise a network (such as a residential network).

The present invention may further provide a computer program product comprising: means to receive (for example at a network address translation device, such as a router) a request from an identity management system to identify a first user device requesting access to a service, wherein the first user device is one of a plurality of user devices communicating with one or more services via a network address translation device that converts an address for each user device known to the apparatus into a common address shared by the user devices; means to identify said first user device; and means to provide data to said identity management system identifying said first user device.

The present invention may further provide a computer program product comprising: means to receive (at an IDM) an assertion request, typically from a network address translation device, such as a router, wherein the assertion request relates to one of a plurality of users or user devices sharing a common address (such as a common IP address, typically the IP address of a router used by the plurality of users); means to send an query to the network address translation device requesting information regarding whether or not the network address translation device can provide a unique address for said user; and means to receive an indication from the network address translation device regarding whether or not the network address translation device can provide said unique address.

The present invention may further provide a computer program product comprising: means to receive an assertion request (from a network address translation device, but originating at a service provider), wherein the assertion request relates to one of a number of users or user devices sharing a common identifier; means to send an query to a local identity management module requesting identification information for the user device; means to receive identification information for the user device from the local identity management module; and means to provide an assertion response to the assertion request.

Exemplary embodiments of the invention are described below, by way of example only, with reference to the following numbered drawings.

FIG. 1 is a block diagram of a system demonstrating the use of a NAT device;

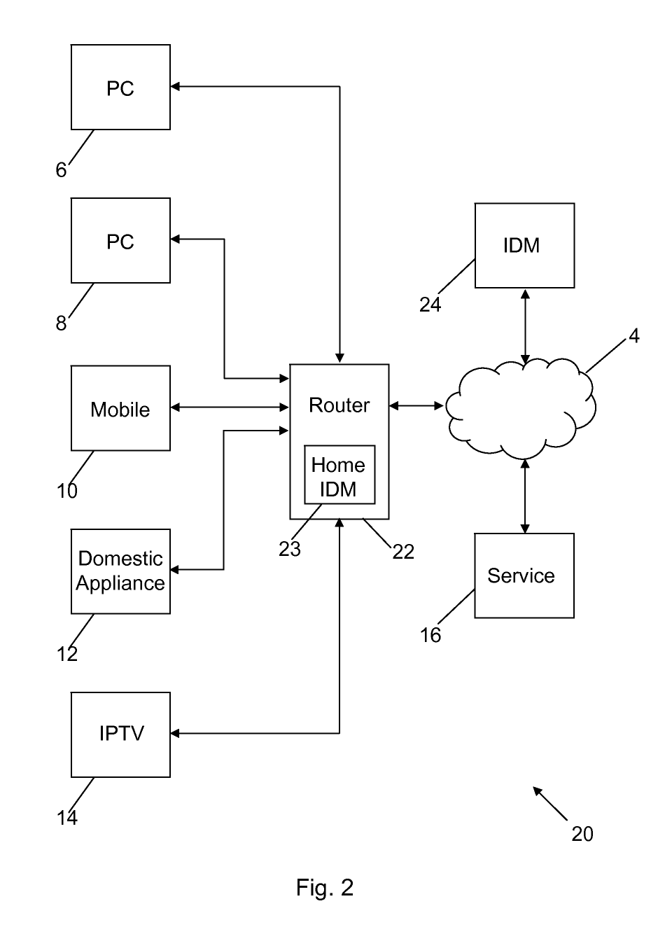

FIG. 2 is a block diagram of a system in accordance with an aspect of the present invention;

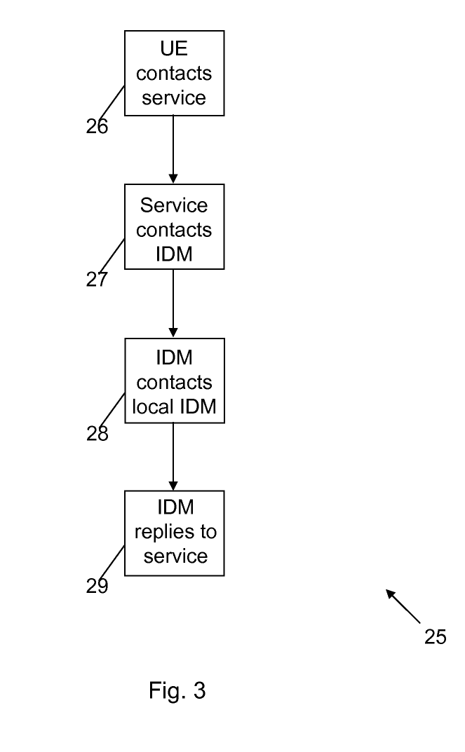

FIG. 3 is a flow chart in accordance with an aspect of the present invention;

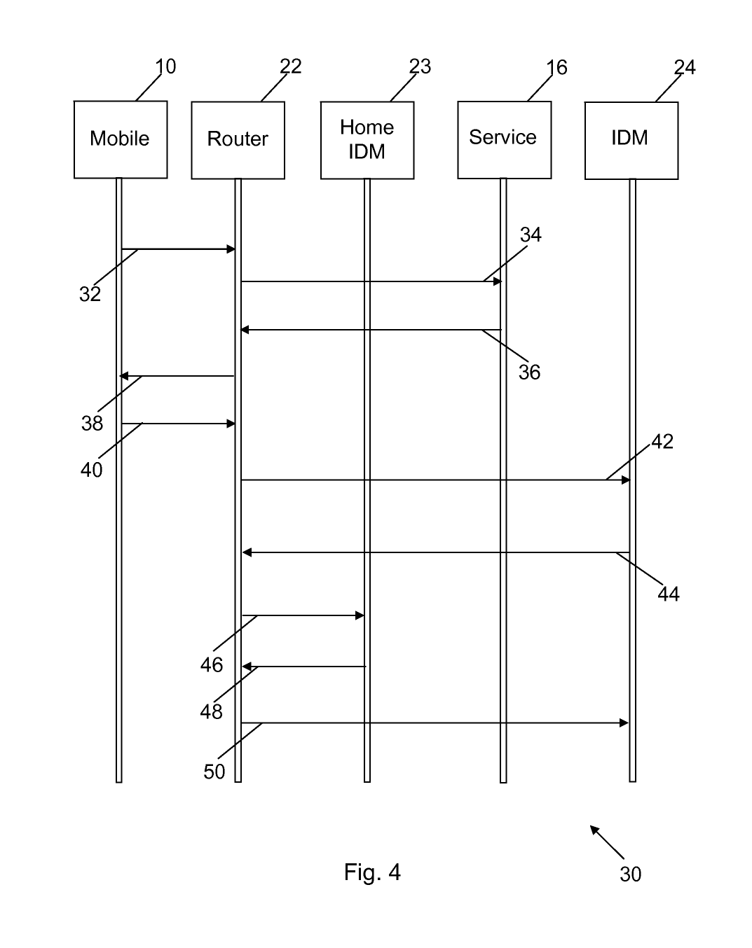

FIG. 4 is a message sequence in accordance with an aspect of the present invention; and

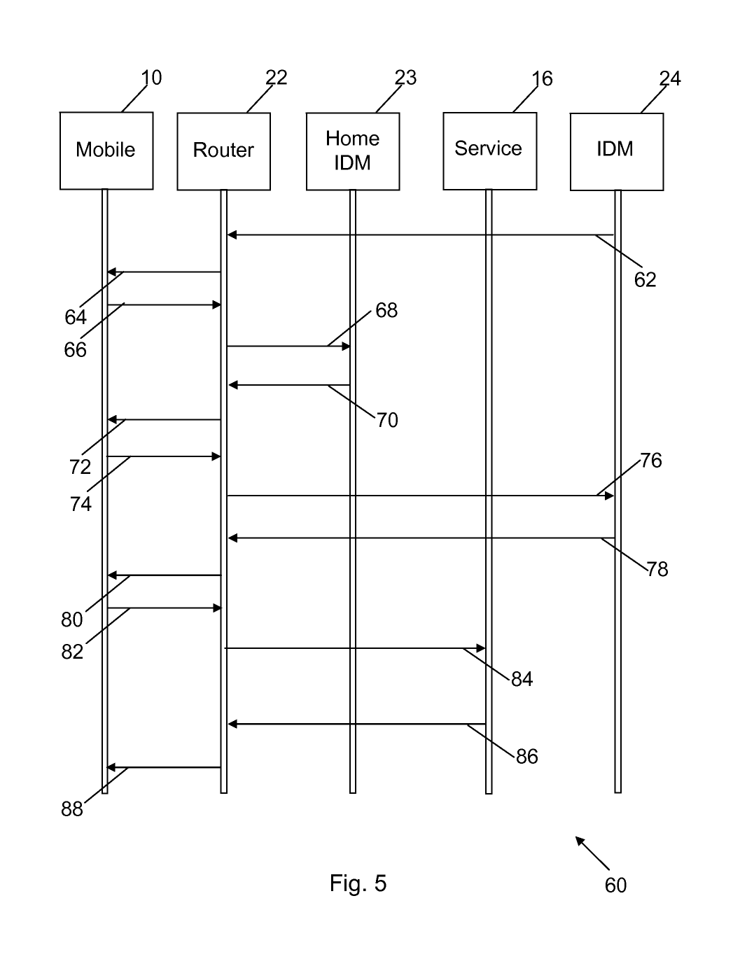

FIG. 5 is a message sequence in accordance with an aspect of the present invention.

FIG. 2 shows a system, indicated generally by the reference numeral 20, in accordance with an aspect of the present invention.

The system 20 includes the first laptop 6, the second laptop 8, the mobile communication device with internet access 10, the smart domestic appliance (such as a refrigerator) 12 and the Internet Protocol television (IPTV) 14 described above with reference to FIG. 1. The system 20 also includes the network 4 and the service 16 described above with reference to FIG. 1. Of course, the devices 6, 8, 10, 12 and 14 connected to the router 12 are exemplary; other devices could be used instead of, or in addition to, any of those devices.

The system 20 differs from the system 1 described above in the provision of a modified router 22 (instead of the router 2) and in the provision of an identity management system (IDM) 24. The modified router 22 is in two-way communication with each of the first laptop 6, the second laptop 8, the mobile communication device 10, the smart domestic appliance 12 and the IPTV 14. The IDM is in two-way communication with the network 4.

The modified router 22 includes a local (or home) identity management module 23. The local identity management module 23 is shown in FIG. 2 as being a part of the modified router 22. This is not essential; for example, the local identity management module 23 could be provided as a separate module that is in communication with the router 22.

The local identity management module 23 acts on behalf of the end-user devices. The local identity management module 23 is not a full IDM, with its own trust relationships, but a remote component of the network operator's IDM system (IDM 24). The operator has both control over the local identity management module 23 (e.g. to check trustworthiness, or to derive pseudonyms) and guarantees trustworthiness (e.g. identity mappings configured by the user are protected even though the end user PC might be infected with malware). The local identity management module 23 acts towards the outside world as an IDM system with the ability to identify the internal network devices and the users assigned or logged in to them. Thus, an external service (such as the service 16) can send queries regarding users to the local IDM module 23. Of course, the module 23 can also act as policy enforcement point for user defined policies.

When, for example, the first laptop 6 communicates with the outside world, the router 22 converts an internal address of the user device 6 to a common internet protocol address, typically the internet protocol address of the router 22. The IDM 24 communicates with the local identity management module 23 in order to identify which of said plurality of user devices made the particular request and, in some embodiments, to identify a user of said user device.

FIG. 3 is a flow chart, indicated generally by the reference numeral 25, demonstrating, in broad terms, an exemplary algorithm in accordance with an aspect of the present invention. The flow chart 25 starts at step 26 where a user device (such as the laptop 6 or 8, the mobile communication device 10, the domestic appliance 12 or the IPTV 14) requests access to a service (such as the service 16). The request may, for example, take the form of an HTTP request.

The service 16 requires the user/user device requesting access to the service to be authenticated. Thus, at step 27, the service 16 requests user authentication information from the IDM 24. This may, for example, be implemented using redirection, whereby the authentication request is sent initially to the user device, with instructions to redirect the request to the IDM 24.

On receipt of the authentication request from the service 16, the IDM 24 contacts the local IDM 23 (step 28). As discussed further below, step 28 may include both determining whether or not a local IDM is able to authenticate the user, and then obtaining user authentication information for the user from that local IDM.

Next, at step 29, the IDM 24 provides the user authentication requested by the service 16 to the service. The service 16 is then able to provide the user with access to the requested service.

FIGS. 4 and 5 show message sequences demonstrating an exemplary implementation of the algorithm 25 described above. FIG. 4 shows a message sequence, indicated generally by the reference numeral 30, in which the user of the mobile communication device 10 wants to login to a service provided the service provider 16, which service requires the operator IDM 24 to provide an identification assertion for the end user. The IDM 24 ascertains that the user credentials can be provided by the local identity management module 23 as described further below. FIG. 5 shows a message sequence, indicated generally by the reference numeral 60, in which the IDM 24 obtains the relevant user credentials from the local identity management module and provides the required assertion to the service, as described further below.

The message sequence 30 begins with the mobile communication device 10 issuing a service access request to the service provider 16 via the router 22. The service access request takes the form of a message 32 sent from the mobile communication device 10 to the router 22 and a subsequent message 34 sent from the router 22 to the service 16. The message 34 is largely the same as the message 32, with the address of the device 10 that is included in the message 32 being changed by the router 22 to the address of the router.

The service provider 16 is adapted to provide single-sign-on (SSO) access to users that can be identified by a suitable identity provider. The service provider 16 redirects the user to the IDM 24. This is achieved by the service provider 16 sending an assertion request to the router 22 (as assertion request 36). The assertion request 36 is forwarded by the router 22 to the mobile communication device 10 as message 38 (with the router 22 determining the identity of the device 10). The assertion request is then sent from the mobile communication device 10 to the IDM 24 via the router 22. Accordingly, the assertion request comprises a message 40 sent from the mobile communication device 10 to the router 22 and a message 42 sent from the router 22 to the IDM 24.

In the absence of the router 22, the IDM 24 would simply identify the mobile communication device 10 on the basis of the IP address of that device and provide an appropriate assertion to the service provider 16. This is not possible in message sequence 30, since the IP address provided for the mobile communication device 10 is the IP address of the router 22.

In the message sequence 30, the IDM 24 determines whether or not the router 22 is associated with a local identity management module. In the event that the IDM 24 determines that the router is associated with a local identity management tool, the IDM 24 checks whether or not the local identity management module is operational by communicating with the local identity management system via the router. As shown in FIG. 4, this is achieved by sending a message 44 from the IDM 24 to the router 22, subsequently sending a message 46 from the router to the local identity management module 23, sending a reply 48 from the local identity management module to the router, and finally sending a reply 50 from the local identity management module to the IDM 24.

Thus, on the receipt of the message 50, the IDM 24 has confirmed that the mobile communication device 10 requesting accesses to the service 16 can be identified by the local identity management module 23.

Next, as shown in the message sequence 60 of FIG. 4, the IDM 24 requests authentication information for the user from the local IDM 23. This is achieved by sending a redirect message from the IDM 24 to the mobile communication device 10 via the router 22 instructing the mobile communication device to obtain the required authentication information from the local identity management module 23.

Thus, the message sequence 60 begins a redirect message 62 being sent from the IDM 24 to the router 22 and a subsequent redirect message 64 being sent from the router 22 to the mobile communication device 10. In response to the redirect message 64, the mobile communication device requests authentication information from the local identity management module 23. This is achieved by sending a message 66 from the mobile communication device 10 to the router 22 and sending a subsequent message 68 from the router 22 to the local identity management module 23.

On receipt of the message 68, the local identity management module obtains the requested authentication information from the user of the mobile communication device 10. This might be achieved in many ways. For example, internal Authentication, Authorization and Accounting (AAA) functions might be used. By way of example, a user of the mobile communication device may authenticate himself at the SIM card of the device using a PIN. When the SIM card is unlocked, the SIM authenticates itself (and the device it is associated with) towards the operator. The AAA server knows the device (and its IP address). If the operator runs a bootstrapping server function (BSF), also this element can be used (instead of AAA). The same can also be achieved using the Information Management System (IMS), if one is in place, using the Session Initiation Protocol (SIP) authentication which is then also bound to the device. The skilled person would be aware of many alternative mechanisms that could be used.

The authentication information is sent to the mobile communication device (via the router) and from the mobile communication device to the IDM 24 (via the router). Thus, a message 70 including the authentication information is sent from the local identity management module 23 to the router 22 and a subsequent message 72 is sent from the router to the mobile communication device 10. Next, a message 74 including the authentication information is sent from the mobile communication device to the router and a subsequent message 76 is sent from the router to the IDM 24.

The IDM 24 now has the authentication information required by the service 16 in order to provide the user with access to that service. This authentication information is sent from the IDM 24 to the service provider via the mobile communication device 10 (by redirection). Thus, the requested assertion is prepared by the IDM 24 and sent as a message 78 from the IDM to the router 22, with the router forwarding the assertion as message 80 to the mobile communication device 10. The mobile communication device sends the assertion as message 82 to the router and the router forwards the assertion as message 84 to the service 16.

At this stage, the service 16 has the credentials required to log-in the user of the mobile communication device 10. Accordingly, the requested service is provided by the service provider 16 to the mobile communication device, as indicated by messages 86 and 88 sent via the router 22.

The present invention can provide one-click WebSSO from an end user behind the NAT device 22 to the service 16, where the operator IDM 24 vouches for the identity of the end user. With this invention seamless handover of identity sessions between devices (e.g. mobile devices), and home sessions is possible. For example after a login to a service from home (via the local identity management module 23), the attributes generated by the local identity management module can be e.g. reused in the mobile case, because the local identity management module and the IDM 24 exchange their information.

The local identity management module 23 maps requests from internal network sources to identities—providing the authentication data to the operator's IDM 24, when necessary. Unlike the end user devices (such as laptops 6 and 8, mobile communication device 10, domestic appliance 12 and IPTV 14), the local identity management module 23 component is especially trusted, can be more easily protected and can be under the control of a third party (e.g. the operator).

In a variant of the invention, if the service 16 is operated by the same operator as the local IDM 23, and the local IDM knows the signature of the service (based on SAML standards), then the redirection via the operator IDM described above is not needed and the service 16 could directly ask the local IDM 23 for authentication.

To authenticate the mobile communication device 10, the local IDM 23 can use for example its IP-Address, MAC Address, used certificate at its https-connection, etc (based on the policy). If the local IDM 23 also acts as a domain server, it can send a challenge to the user, so that the browser would automatically answer with, for example, the user's Kerberos name or username (within the domain). In this way, it is possible for outside services to make use of single-sign-on with help of the internal domain information. Policies could be thought of e.g. some devices can be used by different users, others are always used by the same user. Parental settings could restrict access to certain services between special times of the day, etc.

The message sequences 30 and 60 described above with reference to FIGS. 4 and 5 describe one exemplary protocol for implementing the present invention. A number of different protocols are, of course, possible. In particular, the message sequences 30 and 60 adopt many of the features of the Security Assertion Markup Language (SAML) procedures, but other protocols are possible. For example, in the message sequences 30 and 60, messages are typically sent between the service 16, the local IDM 23 and the IDM 24 via the router mobile device 10 (using redirection). Such redirection need not be used in all implementations of the invention.

The present invention provides a solution to the problem of how to request additional information from a client, if the end-user device is behind a network address translation (NAT) device and does not provide local support for it (e.g. the end-user device is a machine and may or may not provide a user interface). Of course, other protocols and flows could be thought of, too. If, for example, the client device is an IPTV-Box, the client device could connect to the service, the service would then query (e.g. via SOAP) the local IDM for authentication information of the system, that just connected to the service (or the used certificate, etc) and the local IDM would answer respective to its policies with the account name.

If in any case, the local IDM 23 is absolutely unable to identify the user, the local IDM could send a login box (for browser sessions for example) where the user enters his username and password valid for his home network. These data also would then never leave the local network nor would they be usable at any outside system. Even if these are phished, they could not be used, because they can only be used at the local IDM which would accept them only from internal connections.

The local identity management module 23 can reply to requests on a well known port independently and does not require a valid NAT session. It, however, can take into account NAT sessions and internal authentication runs (in variations of the implementation). By way of example, assume that a picture printing internet service is provided and a particular user stores pictures on a desktop personal computer equipped with an additional “serving” application (in the simplest case an extended FTP server). The user tells the service to “fetch” your pictures. Currently, the pictures would have to be upload—but with this invention, the service could query the HomeIDM and then the connection to the server is set up on the external request.

Like an enterprise IDM the local identity management module 23 can provide a user interface listing the different IDs with permissions or attributes assigned. It is possible for the head of a family to get an overview of identities used and linked to pseudonyms. Options like “generate new pseudonym at start of each session” facilitate privacy protection. It is possible to link IDs to devices that have no GUI, but are network addressable, and to link “profiles” and accounts (e.g. monetary) to IDs or pseudonyms. These are policies that could be sent within an administration GUI of the HomeIDM. So, you could define policies that your IPTV-Box should identify itself as “User A” from 08:00 till 17:00 and as “User B” from 17:00 to 8:00.

The embodiments of the invention described above are illustrative rather than restrictive. It will be apparent to those skilled in the art that the above devices and methods may incorporate a number of modifications without departing from the general scope of the invention. It is intended to include all such modifications within the scope of the invention insofar as they fall within the scope of the appended claims.

1. An apparatus comprising:
a first input for receiving a request from an identity management system to identify a first user device requesting access to a service, wherein the first user device is one of a plurality of user devices that communicate with one or more services via a network address translation device that converts an identifier for each of the user devices into a common identifier shared by the user devices;
processing means for identifying said first user device; and
a first output for providing data to said identity management system identifying said first user device.

2. An apparatus as claimed in claim 1, further comprising a second input for receiving a request from the identity management system to indicate whether or not the apparatus is able to provide the said data identifying the first user device.

3. An apparatus as claimed in claim 1, wherein the network address translation device is a router.

4. An apparatus as claimed in claim 1, wherein the common identifier is the address of the network translation device.

5. An apparatus as claimed in claim 1, wherein the apparatus forms part of the said network address translation device.

6. An apparatus as claimed in claim 5, wherein the network address translation device further comprises a third input and a second output, wherein:
the third input is adapted to receive a service access request from one of the plurality of user devices;
the second output is adapted to send an access request to the requested service; and
the access request identifies the requesting user using said common identifier, regardless of the identity of the requesting user device.

7. A system comprising an apparatus as claimed in claim 1, further comprising the said identity management system.

8. An apparatus comprising:
a first input for receiving an assertion request, wherein the assertion request relates to one of a number of user devices sharing a common identifier;
a first output for sending a query to a network address translation device requesting information regarding whether or not the network address translation device can provide a unique identifier for said user; and
a second input for receiving an indication from the network address translation device regarding whether or not the network address translation device can provide said unique address.

9. A method comprising:
receiving a request from an identity management system to identify a first user device requesting access to a service, wherein the first user device is one of a plurality of user devices communicating with one or more services via a network address translation device that converts an identifier for each user device into a common identifier shared by the user devices;
identifying said first user device; and
providing data to said identity management system identifying said first user device.

10. A method as claimed in claim 9, further comprising receiving a request from the identity management system to indicate whether or not data identifying the first user device can be provided.

11. A method as claimed in claim 9, further comprising:
receiving a service access request from one of the plurality of user devices; and
sending an access request to the requested service, wherein the access request identifies the requesting user using said common identifier, regardless of the identity of the requesting user device.

12. A method comprising:
receiving an assertion request, wherein the assertion request relates to one of a plurality of users sharing a common identifier;
sending a query to a network address translation device requesting information regarding whether or not the network address translation device can provide a unique address for said user; and
receiving an indication from the network address translation device regarding whether or not the network address translation device can provide said unique address.

13. A method comprising:
receiving an assertion request, wherein the assertion request relates to one of a number of user devices sharing a common identifier;
sending a query to a local identity management module requesting identification information for the user device;
receiving identification information for the user device from the local identity management module; and
providing an assertion response in response to the assertion request.

14. A method comprising:
sending a service access request from one of a plurality of user devices to a first service via a network address translation device, wherein the network address translation device provides the request in a format that includes a common address, regardless of the internal address of said one of the plurality of user devices;
the first service requesting an identification assertion for the user device from an identity management system;
the identity management system requesting identification information for the user device from a local identity management module;
the local identity management module providing identification information for said one of said plurality of user devices to the identity management system;
the identity management system providing an identity assertion to the service on the basis of identification information received from the local identity management system; and
the first service granting the user device access to the service.

15. A computer program product comprising:
means to receive a request from an identity management system to identify a first user device requesting access to a service, wherein the first user device is one of a plurality of user devices communicating with one or more services via a network address translation device that converts an address for each user device known to the apparatus into a common address shared by the user devices;
means to identify said first user device; and
means to provide data to said identity management system identifying said first user device.

16. A computer program product comprising:
means to receive an assertion request, wherein the assertion request relates to one of a plurality of users sharing a common address;
means to send a query to a network address translation device requesting information regarding whether or not the network address translation device can provide a unique address for said user; and
means to receive an indication from the network address translation device regarding whether or not the network address translation device can provide said unique address.

17. A computer program product comprising:
means to receive an assertion request, wherein the assertion request relates to one of a number of users sharing a common identifier;
means to send a query to a local identity management module requesting identification information for the user device;
means to receive identification information for the user device from the local identity management module; and
means to provide an assertion response to the assertion request.
